(19) United States
(12) Patent Application Publication
(10) Pub. No.: US 2021/0329361 A1
(43) Pub. Date: Oct. 21, 2021

(54) SMART EARSET HAVING KEYWORD WAKEUP FUNCTION

(71) Applicant: Orfeo SoundWorks Corporation, Seoul (KR)

(72) Inventor: Eundong KIM, Uiwang-si (KR)

(73) Assignee: Orfeo SoundWorks Corporation, Seoul (KR)

(21) Appl. No.: 17/292,446

(22) PCT Filed: Nov. 13, 2019
(86) PCT No.: PCT/KR2019/015463

§ 371 Date: May 9, 2021

(30) Foreign Application Priority Data
Nov. 14, 2018 (KR) 10-2018-0139686
Apr. 4, 2019 (KR) 10-2019-0039340
Nov. 13, 2019 (KR) 10-2019-0145034

(51) Int. Cl. H04R 1/10; H04R 1/28; G10L 21/00

(52) U.S. Cl. CPC H04R 1/1016; H04R 1/2826; H04R 2460/03; H04R 1/1083; H04R 2460/11; G10L 21/00

(57) ABSTRACT

Disclosed is a smart earset having a keyword wakeup function. The smart earset having a keyword wakeup function, according to the present invention, comprises: a microphone which generates a voice signal by collecting the voice of an utterer; a control unit which generates a keyword corresponding to the voice signal (wherein the keyword is text that executes a particular program of a particular terminal) and generates a drive signal corresponding to the keyword; and a wireless communication module which is driven correspondingly to the drive signal.

### TECHNICAL FIELD

The present invention relates to a noise blocking headset, and more particularly, to a smart earset having a keyword wakeup function that is capable of stopping driving of a wireless communication module in a standby state of wireless communication to thus minimize power consumption and capable of allowing the wireless communication module to be driven with a given keyword whose voice recognition rate is improved through external noise blocking.

### BACKGROUND ART

With the development of wireless communication technologies, recently, various wireless communication services have been provided. In specific, as near field wireless communication technologies as well as mobile communication technologies are improved, it becomes possible that wireless equipment and terminals provide various wireless communication services including simple massage transmission and multimedia service supply.

So as to develop the near field wireless communication technologies by which surrounding equipment is connected to a big network through wireless communication, moreover, many studies have been actively made. The near field wireless communication technologies include wireless local area network (LAN), Bluetooth, infrared data association (IrDA), ZigBee, ultra-wideband (UWB), and so on. Among them, Bluetooth having a relatively small amount of power consumed is widely used, and technologies for large capacity transmission and minimization of power consumed have been consistently studied.

Recently, many earsets on which a Bluetooth module is mounted have been launched to the market. The earsets can perform various functions like sound outputs, calling, connected terminal control, and so on.

So as to perform a wireless communication service, however, the wireless communication module has to be always kept to an ON-state. Accordingly, power consumption is disadvantageously caused in a standby state. For example, even the Bluetooth module consumes power of 7 to 10 mA in a standby state thereof.

Accordingly, the earset on which the wireless communication module is mounted has limitations in use for long hours, so that there is a need to minimize the power consumption. In specific, there is a need to solve the power consumption problem caused in the standby state.

So as to allow the earset to perform various functions like sound outputs, calling, connected terminal control, and so on, on the other hand, there is a need to improve the voice recognition rate thereof. In particular, there is a need to improve the vice recognition rate of the earset even in a place where external noise is seriously generated.

Here, the structure and problems of earset are discussed briefly.

An earset as a typical in-ear earphone is a sound device inserted into the auricle and the ear canal to listen to sounds.

As the earset is inserted into the ear canal, an atmospheric pressure difference between the inside of the earset (human body pressure) and the outside of the earset (atmospheric pressure) is caused. In specific, an ear tip of the earset comes into close contact with the inner peripheral wall of the ear canal, and accordingly, the atmospheric pressure difference between the inside of the earset and the outside of the earset is made. However, the atmospheric pressure difference has an influence on the vibration plate of a speaker driver unit. In specific, the vibration plate is inclined toward the outside of the earset. In this case, it is hard to output sounds, and further, the sounds are distorted.

So as to prevent the vibration plate from being inclined toward the outside of the earset, a back hole is formed on the rear surface of the speaker driver unit. The back hole communicates with the through hole formed on a case of the earset and thus serves to maintain the atmospheric pressures at the inside and outside of the earset to the same level as each other. Accordingly, the vibration plate can be vibrated at a regular position. In this case, the speaker driver unit is largely classified into a dynamic driver unit and a balanced armature driver unit.

Upon the operation of the vibration plate, on the other hand, artificial control may be performed so as to generate the atmospheric pressure difference, and to do this, the back hole may be covered with dampers having different mesh densities. Through the method, the speaker driver unit can be tuned.

However, the back hole formed on the rear surface of the speaker driver unit undesirably serves as a path through which external noise is introduced. So as to avoid the problem, if the back hole is blocked, the inclination of the vibration plate may occur, so that the earset cannot be used at the interior of an airplane or on a high mountain area. Further, if the back hole of the speaker driver unit is blocked, the vibration plate is suppressed from being vibrated to thus cause the sounds to be distorted.

Accordingly, there is a need for developing a new earset capable of preventing external noise from being introduced thereinto through the back hole formed on the rear surface of the speaker driver unit so that the qualities of speaker sounds and an utterer's voice can be improved.

### DISCLOSURE

### Technical Subject

Accordingly, the present invention has been made to solve the above-mentioned problems, and it is an object of the present invention to provide a smart earset having a keyword wakeup function that is capable of stopping driving of a wireless communication module in a standby state of wireless communication to thus minimize power consumption and capable of allowing the wireless communication module to be driven correspondingly to a given keyword.

It is another object of the present invention to provide a smart earset having a keyword wakeup function that is capable of blocking external noise to thus improve a voice recognition rate of a given keyword.

### Technical Solution

To accomplish the above-mentioned objects, according to the present invention, there is provided a smart earset having a keyword wakeup function, including: a microphone for collecting an utterer's voice to generate a voice signal; a control unit for generating a keyword (wherein the keyword is a text that executes a particular program of a particular terminal) corresponding to the voice signal and generating a drive signal corresponding to the keyword; and a wireless communication module driven correspondingly to the drive signal. In this case, the microphone and the control unit are constituted as one chip.

According to the present invention, the wireless communication module includes: a controller for driving a communication processing unit according to the drive signal and generating a conversion signal with which the communication processing unit is converted to a standby state under conditions set in advance; and the communication processing unit for performing communication processing for signals inputted and outputted thereto and therefrom, and the control unit serves as a keyword determining unit for determining whether the keyword exists. In this case, the control unit, the controller, and the communication processing unit are constituted as one chip.

According to the present invention, the microphone is an in-ear microphone that is isolatedly built from a speaker driver unit in which a back hole is formed, the speaker driver unit and the in-ear microphone being built in a case with a through hole formed thereon in such a manner as to be isolated from the through hole by means of a separator having a microhole adapted to allow the through hole to communicate with the back hole, and between the microhole and the back hole is formed a resonance space.

According to the present invention, in this case, the separator having the microhole is a resonance case adapted to cover the rear surface of the speaker driver unit on which the back hole is formed.

According to the present invention, further, the separator is an inner wall of the case or a printed circuit board (PCB).

### Advantageous Effects

According to the present invention, the smart earset having the keyword wakeup function can stop driving of the wireless communication module in a standby state of wireless communication and can allow the wireless communication module to be driven correspondingly to the given keyword, thereby minimizing power consumption.

In addition, the smart earset having the keyword wakeup function according to the present invention can block external noise to thus improve the qualities of speaker sounds and the utterer's voice and the voice recognition rate of the given keyword.

### BRIEF DESCRIPTION OF DRAWINGS

FIG. 1 is a block diagram showing a control circuit of a smart earset having a keyword wakeup function according to an embodiment of the present invention.

FIG. 2 is a block diagram showing a control circuit of a smart earset having a keyword wakeup function according to another embodiment of the present invention.

FIG. 3 is a concept view showing the smart earset having a keyword wakeup function according to the embodiment of the present invention.

FIG. 4 is a concept view showing the smart earset having a keyword wakeup function according to another embodiment of the present invention.

FIG. 5 is a concept view showing a smart earset having a keyword wakeup function according to yet another embodiment of the present invention.

FIG. 6 is a concept view showing a smart earset having a keyword wakeup function according to still another embodiment of the present invention.

FIG. 7 is a flowchart showing a process wherein the smart earset having a keyword wakeup function according to the embodiment of the present invention is interlinked with a smartphone.

FIG. 8 is a flowchart showing a process wherein the smart earset having a keyword wakeup function according to another embodiment of the present invention is interlinked with a smartphone.

FIG. 9 is a flowchart showing a process wherein the smart earset having a keyword wakeup function according to the present invention is interlinked with a specific device.

### BEST MODE FOR INVENTION

According to the present invention, a smart earset having a keyword wakeup function includes: a microphone for collecting an utterer's voice to generate a voice signal; a control unit for generating a keyword (wherein the keyword is a text that executes a particular program of a particular terminal) corresponding to the voice signal and generating a drive signal corresponding to the keyword; and a wireless communication module driven correspondingly to the drive signal.

### MODE FOR INVENTION

Hereinafter, the present invention will now be described in detail with reference to the attached drawings wherein the corresponding parts in the embodiments of the present invention are indicated by corresponding reference numerals.

In the description, when it is said that one portion is described as “includes” any component, one element further may include other components unless no specific description is suggested.

The terms “means”, “unit”, “module”, or “block” in the specification and claims indicate a unit for processing at least one function or operation, which may be implemented by hardware, software, or a combination thereof.

Near field wireless communication technologies applicable in the present invention include wireless LAN, Bluetooth, IrDA, ZigBee, UWB, and so on, but an embodiment wherein Bluetooth is used as the near field wireless communication technology will be described below. Of course, other examples as the near field wireless communication technologies may be applied to the present invention.

In explaining the operations of a smart earset having a keyword wakeup function according to the present invention, further, the operations between the earset and a smartphone will be explained. In addition to the smartphone, of course, the earset according to the present invention may be connected to a terminal connectable through wireless communication and thus communicates to the terminal.

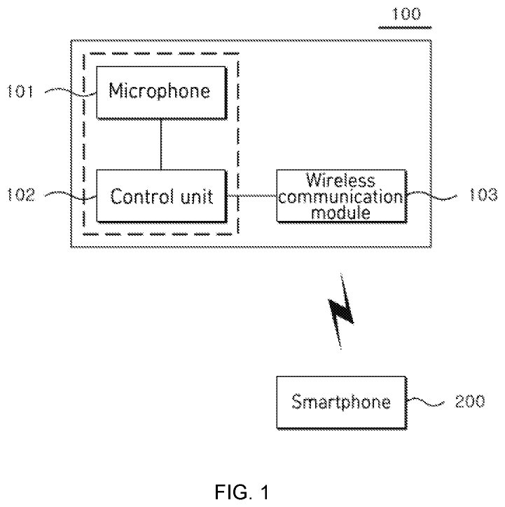

FIG. 1 is a block diagram showing a control circuit of a smart earset having a keyword wakeup function according to an embodiment of the present invention.

Referring to FIG. 1, a smart earset 100 having a keyword wakeup function according to an embodiment of the present invention includes a microphone 101 for collecting an utterer's voice to generate a voice signal, a control unit 102 for generating a keyword corresponding to the voice signal and generating a drive signal corresponding to the keyword, and a wireless communication module 103 driven correspondingly to the drive signal.

In this case, the keyword is a text that executes a particular program of a particular terminal. That is, the keyword may be the name of an application installed on a smartphone 200, such as “Siri”, “Bixby”, “OK Google”, or the like, and otherwise, the keyword may be the name for driving a particular terminal. Accordingly, the keyword is in advance set according to a program or is arbitrarily set by a user. Like this, the keyword may serve to drive a given terminal among a plurality of terminals registered or to execute a given program installed in one terminal.

Also, the control unit 102 serves to determine whether the keyword corresponding to the voice signal is a set keyword or not and to control the power source of the wireless communication module 103.

According to the present invention, an embodiment wherein the smart earset 100 is driven by the voice signal produced from the microphone 101, but of course, whether the wireless communication module 103 is driven can be controlled by means of various interface means like a button, a sensor, and so on, which is located on the smart earset 100.

As indicated by a dotted line, on the other hand, the microphone 101 and the control unit 102 can be constituted as one chip. That is, as mentioned above, the power source supplied to the wireless communication module 103 can be controlled by means of the control unit 102.

According to the present invention, a Bluetooth module is used as the wireless communication module 103. In the case where the microphone 101 and the control unit 102 are constituted as one chip, only the Bluetooth module is replaceable. Of course, the replacement to other near field wireless communication modules may be possible.

Further, the control unit 102 performs conversion control to a standby state according to the signal of the microphone 101 or an external signal (conversion signal). That is, the control unit 102 generates a conversion signal to a wireless communication standby state under conditions set in advance. Accordingly, the driving of the wireless communication module 103 is stopped correspondingly to the conversion signal.

Even though not shown, on the other hand, a storage unit in which the keyword is stored is connected to the control unit 102, and the comparison between the generated keyword and the stored keyword is carried out according to the request of the control unit 102.

Under the above-mentioned configuration of the smart earset 100 according to the embodiment of the present invention, pairing of the smart earset 100 to the smartphone 200 is carried out, and if the wireless communication module 103 is converted to the standby state under the conditions set in advance, after that, the power source supplied to the wireless communication module 103 is blocked. That is, only the microphone 101 and the control unit 102 are driven, and the driving of the wireless communication module 103 is stopped, so that the smart earset 100 can be driven with minimum power. If a voice signal is produced in the standby state, the keyword corresponding to the voice signal is produced to thus determine whether the produced keyword exists in the keywords set in advance. If the produced keyword exists therein, the wireless communication module 103 is driven to perform communication connection control with the smartphone 200 according to the corresponding keyword.

On the other hand, the conditions wherein the wireless communication module 103 is converted to the standby state may be given by means of a user's control of the smart earset 100 and the smartphone 200 if the voice is not produced for a given set time.

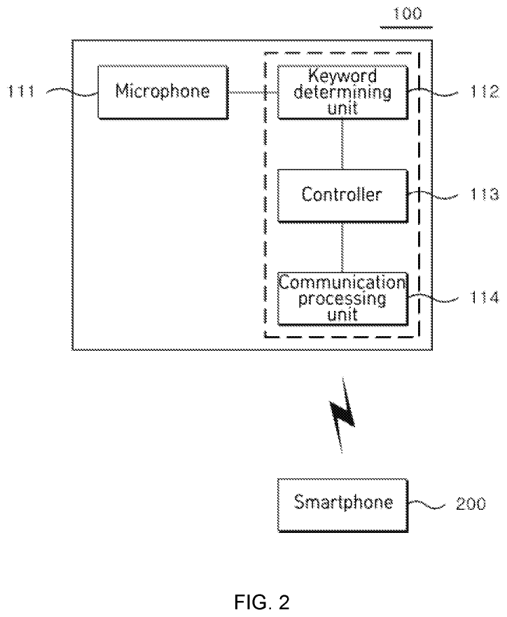

FIG. 2 is a block diagram showing a control circuit of a smart earset having a keyword wakeup function according to another embodiment of the present invention.

For the brevity of the description, on the other hand, an explanation of only the differences of the smart earset of FIG. 2 from that of FIG. 1 will be given.

Referring to FIG. 2, a smart earset 100 having a keyword wakeup function according to another embodiment of the present invention includes a microphone 101 for collecting an utterer's voice to generate a voice signal, a keyword determining unit 112 for generating a keyword corresponding to the voice signal and, if the generated keyword is a keyword set in advance, for generating a drive signal corresponding to the keyword, a controller 113 for driving a communication processing unit 114 according to the drive signal and generating a conversion signal with which the communication processing unit 114 is converted to a standby state under conditions set in advance, and the communication processing unit 114 for performing communication processing for signals inputted and outputted thereto and therefrom.

When compared to the smart earset 100 as shown in FIG. 1 wherein the control unit 102 performs the keyword determination and the control of the power source, the keyword determining unit 112 of the smart earset 100 as shown in FIG. 2 performs only some functions among the functions of the control unit 102 as shown in FIG. 1. That is, the keyword determining unit 112 serves to determine whether the generated keyword is the keyword set in advance, and the controller 113 serves to supply the power source or block the supply of the power source.

Further, the controller 113 performs conversion control to a standby state according to the signal of the microphone 101 or an external signal (conversion signal). That is, the controller 113 generates a conversion signal to a wireless communication standby state under conditions set in advance. Accordingly, the driving of the controller 113 and the communication processing unit 114 is stopped correspondingly to the conversion signal.

As indicated by a dotted line, on the other hand, the keyword determining unit 112, the controller 113, and the communication processing unit 114 can be constituted as one chip. That is, only the microphone 111 and the keyword determining unit 112 are normally driven, and before a voice signal or an event signal is generated, the controller 113 and the communication processing unit 114 are kept to the standby state. Accordingly, the power source supplied to the communication processing unit 114 can be controlled by means of the controller 113.

According to the present invention, in the case where the keyword determining unit 112, the controller 113, and the communication processing unit 114 are constituted as one chip, one chip and the microphone 111 constitute the smart earset 100, thereby achieving part exchanging and replacement to other wireless communication modules with ease.

According to another embodiment of the present invention, a Bluetooth module may be used as the communication processing unit 114.

Under the above-mentioned configuration of the smart earset 100 according to another embodiment of the present invention, pairing of the smart earset 100 to the smartphone 200 is carried out, and if the communication processing unit 114 is converted to the standby state under the conditions set in advance, after that, the power source supplied to the communication processing unit 114 is blocked by means of the controller 113. Further, the driving of the controller 113 itself is stopped. In this case, the keyword determining unit 112 is kept to an ON state. That is, only the microphone 111 and the keyword determining unit 112 are driven, and the driving of the controller 113 and the communication processing unit 114 is stopped, so that the smart earset 100 can be driven with minimum power. If a voice signal is produced in the standby state, the keyword determining unit 112 determines whether the voice signal corresponds to the keyword existing in the keywords set in advance. If the voice signal corresponds to the keyword, the controller 113 is driven, and the communication processing unit 114 is sequentially driven through the continuous control of the controller 113, thereby performing the communication between the smart earset 100 and the smartphone 200.

On the other hand, the conditions wherein the controller 113 and the communication processing unit 114 are converted to the standby state may be given by means of a user's control of the smart earset 100 and the smartphone 200 if the voice is not produced for a given set time.

In the case where the wireless communication to the smartphone 100 is carried out through the smart earset 100 according to the present invention, on the other hand, whether the keyword is generated from the smart earset 100 is important. Accordingly, there is a need to improve a recognition rate of an utterer's voice in a state where external noise exists, which requires a technology capable of removing the external noise from the earset. Hereinafter, configurations and functions of the smart earset 100 according to embodiments of the present invention will be explained.

Before the explanation, first, kinds of holes as will be described below will be explained.

Firstly, a back hole BH represents a hole formed on the rear surface of a speaker driver unit.

Secondly, a microhole H represents a hole with a diameter of 100 μm or less, desirably, with a diameter of 40 μm or less.

Lastly, a through hole 0 represents a hole with a diameter of 100 μm or more.

Hereinafter, an explanation of a smart earset having a keyword wakeup function according to embodiments of the present invention will be given.

Before the description, the embodiments of the present invention will be explained in the order as follows.

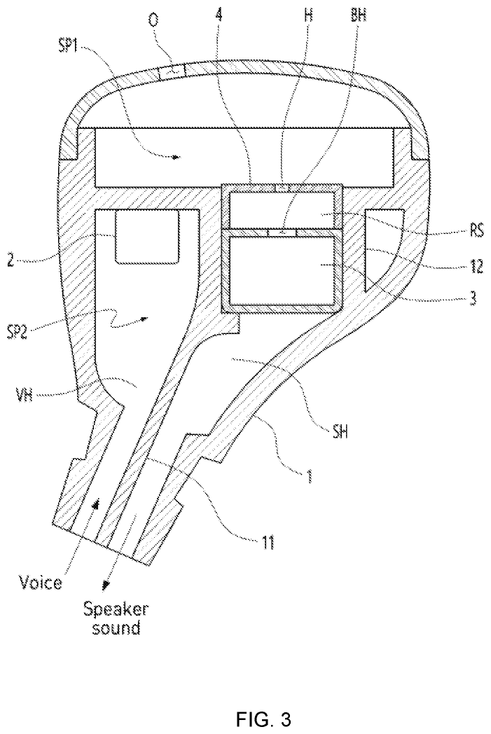

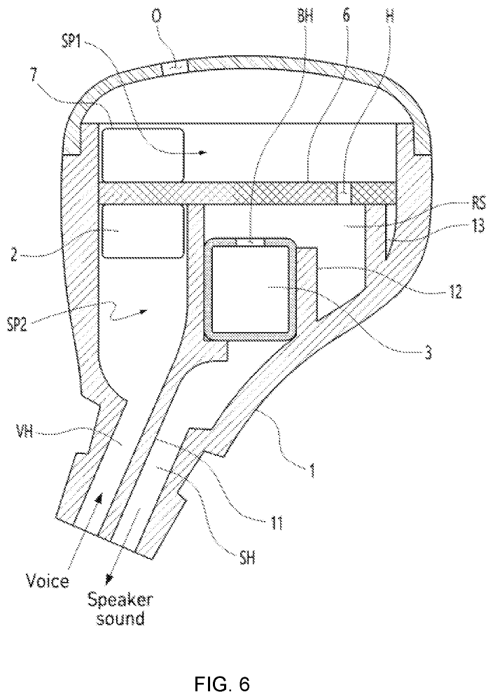

First, the embodiments in which a speaker driver unit and an in-ear microphone are built in the smart earset having a keyword wakeup function according to the present invention will be explained (with reference to FIGS. 3 to 5). Next, the embodiment in which a speaker driver unit, an in-ear microphone, and an out-ear microphone are built in the smart earset having a keyword wakeup function according to the present invention will be explained (with reference to FIG. 6).

However, the technology suggested in the present invention may be applied to an embodiment wherein the speaker driver unit and the out-ear microphone are built in the smart earset according to the present invention and to an embodiment wherein only the speaker driver unit is built therein.

FIG. 3 is a concept view showing the smart earset having a keyword wakeup function according to the embodiment of the present invention.

Referring to FIG. 3, the smart earset having a keyword wakeup function according to the embodiment of the present invention includes a case 1 having a through hole O, an in-ear microphone 2 provided inside the case 1 to collect sounds received from the ear canal, and a speaker driver unit 3 provided inside the case 1 to output sounds to the ear canal.

In this case, further, a resonance case 4 is provided on the rear surface of the speaker driver unit 3, on which a back hole BH is formed.

Further, the resonance case 4 has a microhole H with a size capable of blocking external noise.

On the other hand, the microhole H may be formed at the position of the back hole BH of the speaker driver unit 3 by means of a laser, but in this case, a machining cost may be disadvantageously raised.

According to the present invention, as a result, the microhole H having a minimum diameter capable of blocking the external noise is formed on the resonance case 4. In specific, the microhole H has desirably a diameter of 100 μm or less, more desirably a diameter of 40 μm or less.

Also, the speaker driver unit 3 is selected from a dynamic driver unit and a balanced armature driver unit. If the dynamic driver unit as the speaker driver unit 3 is selected, the resonance case 4 is covered to a similar shape to the rear surface shape of the speaker driver unit 3 where the back hole BH is formed or to the same shape as the rear surface shape of the speaker driver unit 3. Generally, the resonance case 4 has a shape of a cylinder. On the other hand, if the balanced armature driver unit as the speaker driver unit 3 is selected, the resonance case 4 is covered to a similar shape to the rear surface shape of the speaker driver unit 3 where the back hole BH is formed or to the same shape as the rear surface shape of the speaker driver unit 3. Further, the contact surface between the rear surface of the speaker driver unit 3 and the resonance case 4 is sealed.

According to the present invention, the embodiment in which one in-ear microphone 2 and one speaker driver unit 3 are provided, but of course, two or more in-ear microphones 2 and two or more speaker driver units 3 may be provided.

According to the present invention, further, installation spaces SP1 and SP2 are separated through, for example, inner walls 11 and 12 and the resonance case 4, but they may be separated through the case, an inner wall separable from the case or coupled integrally with the case, or a printed circuit board (PCB). In specific, the installation spaces SP1 and SP2 can be separated through a separator having the case, the inner wall, or the PCB. If a resonance space RS is formed through the case, the inner wall, or the PCB, accordingly, the microhole H may be formed on the case, the inner wall, or the PCB.

If the inner wall as the separator is used, the resonance space RS is formed to a shape of a cylinder or polygon extended from the inner wall on which the microhole H is formed toward the speaker driver unit 3. In specific, in the case of the dynamic driver unit, the resonance space RS has a generally cylindrical shape, and in the case of the balanced armature driver unit, the resonance space RS has a shape of a generally rectangular post. As described above, of course, the resonance space RS desirably has a similar shape to the rear surface shape of the speaker driver unit 3 or has the same shape as that of the speaker driver unit 3. Further, the contact surface between the rear surface of the speaker driver unit 3 and the resonance case 4 is sealed.

If the PCB as the separator is used, further, the PCB is generally flat, and accordingly, the PCB is mounted to close a section cut at a given position of the case 1. When the given position of the case 1 is cut, in specific, the PCB perfectly closes the open region. Further, one surface of the PCB is located toward the installation space SP1, and the other surface is located toward the installation space SP2. In this case, the inner wall 11 through which the installation space SP2 is separated comes into contact with the PCB and is thus closed. Accordingly, the speaker driver unit 3 and the in-ear microphone 2 can be separatedly located around the inner wall 11.

The microhole H, which is formed in the smart earset, through the various methods as mentioned above, serves to allow the back hole BH of the speaker driver unit 3 to communicate with the through hole O formed on the case 1.

In more specific, the technology in which the installation spaces SP1 and SP2 are separated from each other will be explained.

The interior of the case 1 is separated into the outer space SP1 and the inner space SP2 by means of the separator. According to the present invention, the inner walls 11 and 12 and the resonance case 4 constitute the separator. Of course, only the resonance case 4 can constitute the separator.

The inner space SP2 is separated through the first inner wall 11. Further, the in-ear microphone 2 is built in one side space separated through the first inner wall 11, and the speaker driver unit 3 is built in the other side space separated through the first inner wall 11.

The speaker driver unit 3 and the resonance case 4 are fitted to the space between the first inner wall 11 and the second inner wall 12 to spatially separate the outer space SP1 and a speaker sound path SH from each other. The in-ear microphone 2 is located on a microphone sound collecting path VH. That is, one side space where the in-ear microphone 2 is mounted forms the microphone sound collecting path VH, and the other side space where the speaker driver unit 3 is mounted forms the speaker sound path SH and the resonance space RS. Like this, one side space is used as the microphone sound collecting path VH. In this case, the microphone sound collecting path VH is formed on a nozzle portion of the space through the first inner wall 11 and the case 1, and the microphone sound collecting path VH is formed on a body center of the space through the first inner wall 11 and a separate voice guide inner wall (not shown). On the other hand, the other side space is used as the speaker sound path SH. In this case, the speaker sound path SH is formed on a nozzle portion of one side space through the first inner wall 11 and the case 1, and the speaker sound path SH or the resonance space RS is formed on a body center of one side space through the selection of the first inner wall 11, the second inner wall 12, and the case 1. Accordingly, the straightness of speaker playing sounds can be improved and low-frequency sounds can be gently played.

On the other hand, the diameter of the microhole H formed on the separator is desirably set according to the thickness of the separator. For example, a ratio of the diameter of the microhole H to the thickness of the separator is set to 1:100 to 1,000, desirably 1:1,000 or more. For example, if the thickness of the separator is 1 mm (1,000 μm), the diameter of the microhole H is set to the range of 1 to 10 μm.

Under the above-mentioned configuration, the smart earset according to the present invention can block external noise by means of the microhole H formed on the separator such as the case, the inner wall, or the PCB, and can maintain atmospheric pressures at the inside and outside of the earset to the same level as each other. Further, the resonance space RS is formed between the microhole H and the rear surface of the speaker driver unit 3 on which the back hole BH is formed, thereby abundantly strengthening sounds.

In addition, the microhole H having a relatively small diameter is formed between the back hole BH and the through hole O, thereby serving as a low pass filter. When signal processed data through the microhole H is transmitted through a network, a high frequency range and a low frequency range are removed out of a bandwidth so as to reduce the quantity of data. In this case, the signal passing through the microhole H is in the low frequency range (below 100 Hz), and accordingly, the signal has no influence on the quantity of data.

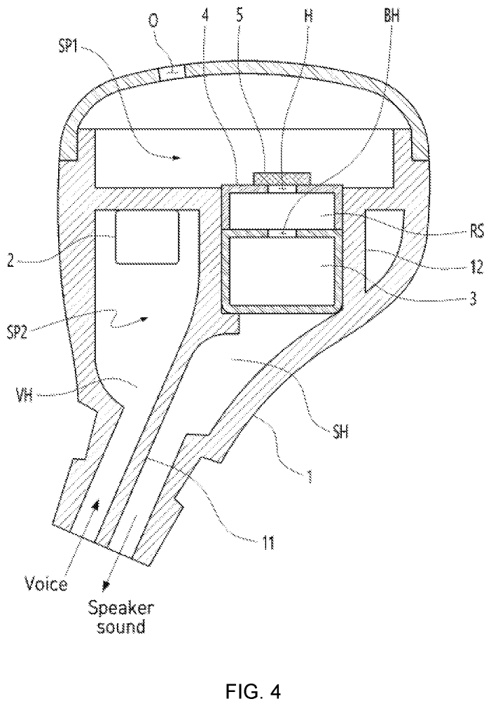

FIG. 4 is a concept view showing the smart earset having a keyword wakeup function according to another embodiment of the present invention.

For the brevity of the description, on the other hand, an explanation of only the differences of the smart earset of FIG. 4 from that of FIG. 3 will be given.

Referring to FIG. 4, the smart earset according to another embodiment of the present invention is configured to have a through hole O formed on a resonance case 4 and to thus allow the through hole O to be covered with a mesh 5.

In specific, the through hole O with a larger diameter by 10 times than a hole with a minimum diameter (40 μm) capable of blocking external noise is formed, and next, the through hole O is covered with the mesh 5 having a density inversely proportional to the diameter of the through hole O. In this case, the density of the mesh 5 is determined in consideration of tuning, desirably in the range of ±20%. This is because the external noise is blocked out by means of the combination of the through hole O and the mesh 5. Through the interaction of the through hole O and the mesh 5, accordingly, the external noise can be blocked and the atmospheric pressures at the inside and outside of the earset can be maintained at the same level as each other.

If it is considered that the hole capable of blocking external noise has the diameter of about 40 μm, the through hole (microhole H) having a larger diameter (in the range of 0.4 to 0.6 mm) by 10 times than the hole is formed, and so as to add noise blocking capability to the through hole O that lacks the noise blocking capability as well as to provide sound tuning, the through hole O is covered with the mesh 5 having a high density of 300 to 600, so that the external noise can be prevented from being introduced into the ear canal and the in-ear microphone 2. That is, a desired technology for the in-ear microphone 2 can be embodied.

On the other hand, the embodiment wherein the through hole O is covered with the mesh 5 has been explained, but of course, the through hole O may be covered with a pad (not shown) on which a microhole is formed. Further, the mesh 5 may be covered on the microhole H of FIG. 1 for the purpose of tuning.

As shown in FIGS. 3 and 4, the smart earset according to the present invention is configured to locate the resonance case 4 on the rear surface of the speaker driver unit 3 so as to block external block, thereby improving the qualities of sounds and preventing the external noise from being introduced into the in-ear microphone 2. That is, the earset according to the present invention can prevent the external noise introduced through the back hole BH formed on the rear surface of the speaker driver unit 3 from being transmitted to the utterer's ear canal or prevent the external noise from being inputted to the in-ear microphone 2 along the speaker sound path SH and the microphone sound collecting path VH. Further, the earset according to the present invention is configured to allow the resonance space RS to be formed on the rear surface of the speaker driver unit 3 in such a manner as to communicate with the through hole O of the case 1, thereby improving back volumes and maintaining the atmospheric pressures at the inside and outside of the earset to the same levels as each other. Accordingly, the low frequency sounds of the speaker driver unit 3 can be strengthened to thus improve the qualities of sounds.

In specific, the earset according to the present invention is configured to allow the microhole H with the diameter of 100 μm, desirably about 40 μm that is capable of blocking external noise to be formed directly on the resonance case 4. Otherwise, the through hole O having the diameter of 100 μm or more is formed on the resonance case 4, and then, the through hole O is covered with the mesh 5 having the density inversely proportional to the diameter of the through hole O. Otherwise, the microhole H with the diameter of 100 μm, desirably about 40 μm that is capable of blocking external noise is formed on the resonance case 4, and for the purpose of tuning, next, the microhole H is covered with the mesh 5.

Through the resonance case 4 on which the microhole H is formed, accordingly, the atmospheric pressures at the inside and outside of the earset can be maintained to the same level as each other and the external noise introduced through the through hole O formed on the case 1 can be blocked.

Further, the resonance space RS is expanded by means of the resonance case 4, thereby increasing the back volumes, strengthening the low frequency sounds and improving the quality of sounds. Even if the sounds are reversely outputted through the back hole BH and the microhole H (the through hole O and the mesh 5, or the microhole H and the mesh 5) by means of the operation of the speaker driver unit 3, the sounds pass through the microhole H (the through hole O and the mesh 5, or the microhole H and the mesh 5) of the resonance case 4, so that only the low frequency sounds in the frequency of 100 Hz is outputted to thus block even the sounds leaking through the through hole O of the case 1.

On the other hand, the smart earsets as suggested in FIGS. 3 and 4 each are configured to locate the resonance case 4 at the inside of the case 1, so that it requires a space for locating the resonance case 4 therein.

Accordingly, an explanation of a method for directly forming the microhole on the case, the inner wall, or the PCB that constitutes the separator will be given below.

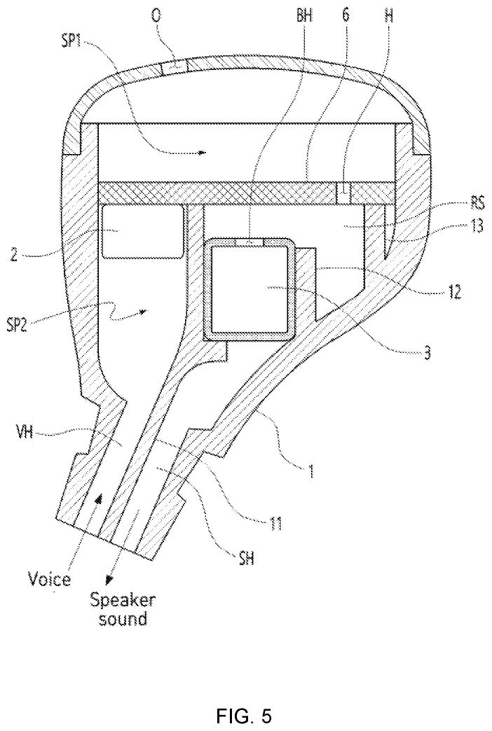

FIG. 5 is a concept view showing a smart earset having a keyword wakeup function according to yet another embodiment of the present invention.

For the brevity of the description, on the other hand, an explanation of only the differences of the smart earset of FIG. 5 from those of FIGS. 3 and 4 will be given.

Referring to FIG. 5, the smart earset according to yet another embodiment of the present invention includes a case 1, a separator 6 for separating the space formed at the inside of the case 1 into an outer space SP1 and an inner space SP2 and having a microhole H formed thereon, a first inner wall 1 for isolating the inner space SP2, an in-ear microphone 2 built in one side space separated through the first inner wall 1, a speaker driver unit 3 built in the other side space separated from the first inner wall 11, a second inner wall 12 for forming an installation space of the speaker driver unit 3, and a third inner wall 13 for forming a resonance space RS communicating with the rear surface of the speaker driver unit 3 on which a back hole BH is formed in such a manner as to be formed at a position allowing the resonance space RS to communicate with the microhole H.

The case, the inner wall, or a PCB may be used as the separator 6, and according to the present invention, the PCB is used as the separator 6. That is, the microhole H is formed on the PCB 6.

On the other hand, one side space is used as a microphone sound collecting path VH. In this case, the microphone sound collecting path VH is formed on a nozzle portion of one side space through the first inner wall 11 and the case 1, and the microphone sound collecting path VH is formed on a body center of one side space through the first inner wall 11 and a separate voice guide inner wall (not shown). On the other hand, the other side space is used as a speaker sound path SH. In this case, the speaker sound path SH is formed on a nozzle portion of the other side space through the first inner wall 11 and the case 1, and the speaker sound path SH or the resonance space RS is formed on a body center of the other side space through the selection of the first inner wall 11, the second inner wall 12, and the case 1. Accordingly, the straightness of speaker playing sounds can be improved and low-frequency sounds can be gently played. Further, the PCB 6 can be seated through the first inner wall 11 and the third inner wall 13.

On the other hand, a through hole O may be formed at a position of the microhole H. That is, if the through hole O having a diameter of 10 μm or more is formed at the position of the microhole H, the through hole O may be covered with a pad (not shown) on which a microhole is formed. Further, the embodiment in which the through hole O is covered with the pad has been explained, but the pad on which the microhole is formed may be directly mounted on the back hole BH of the speaker driver unit 3.

On the other hand, the pad is mounted on the outer space SP1 or the inner space SP2, and otherwise, the pad may be mounted directly on the PCB 6.

Various tuning may be possible according to the diameter size of the microhole formed on the pad. Further, if the pad is made in the form of a mesh, the tuning may be different according to the density of the mesh.

On the other hand, the speaker driver unit 3 is located on a speaker sound path SH, and in specific, the speaker driver unit 3 is located at the nozzle of the speaker sound path SH. Accordingly, the speaker sound path SH is short in front of the speaker driver unit 3, and the relatively large resonance space RS is formed behind the speaker driver unit 3.

FIG. 6 is a concept view showing a smart earset having a keyword wakeup function according to still another embodiment of the present invention.

For the brevity of the description, on the other hand, an explanation of only the differences of the smart earset of FIG. 6 from those of FIGS. 3 to 5 will be given.

Referring to FIG. 6, the smart earset according to still another embodiment of the present invention further includes an out-ear microphone 7 located inside the case 1 to collect the sounds (voice and external noise) received from the outside thereof.

The out-ear microphone 7 is built in the outer space SP1. Further, the case 1 has a through hole O adapted to maintain an atmospheric pressure and to collect sounds.

According to the present invention, that is, the smart earset is configured to have the case 1 with the through hole O formed thereon to allow the voice and external noise introduced through the through hole O to be inputted to the out-ear microphone 7, so that the out-ear microphone 7 checks whether an utterer's voice is produced or makes use of the voice inputted to the in-ear microphone 2 with reference to the utterer's voice inputted thereto as a reference signal for restoring to the utterer's original voice thereof. On the other hand, if the external noise with which the utterer's voice is mixed is greater than a set value, for example, 40 db, driving of the out-ear microphone 7 is stopped, and only the in-ear microphone 2 is driven, thereby desirably restoring to the utterer's original voice.

According to the smart earsets as suggested in FIGS. 3 to 6, further, the embodiments in which the microhole H or the through hole O and the mesh 5 is (are) formed on the resonance case 4 have been explained, but of course, the microhole H and the mesh may be formed on the resonance case 4. So as to achieve double noise blocking and tuning of the speaker driver unit 3, that is, the microhole H and the mesh 5 may be formed on the resonance case 4. As the resonance space RS is formed, accordingly, the vibration plate of the speaker driver unit 3 can be prevented from being inclined toward the outside of the earset. Therefore, the through hole O formed on the case 1 may be replaced with the microhole H. Accordingly, primary noise blocking is obtained through the microhole H formed on the case 1, and secondary noise blocking is obtained through the selection of the microhole H formed on the resonance case 4, the combination of the through hole O and the mesh 5, or the selective combination of the microhole H and the mesh 5.

Hereinafter, an explanation of an operation process of the smart earset having the keyword wakeup function according to the present invention will be given.

First, it is assumed that the smart earset having the keyword wakeup function is paired to a smartphone, and so as to perform the pairing, wire/wireless communication, desirably near field communication (NFC) such as Wi-Fi, Bluetooth, and so on is used. According to the present invention, an explanation of the operating process of the smart earset paired to the smartphone through Bluetooth will be given.

According to the present invention, on the other hand, transmitting and receiving processes between the smart earset having the keyword wakeup function and the smartphone in the state where the smart earset is paired to the smartphone will be described, but the functions of the smartphone may be provided in the smart earset itself having the keyword wakeup function, so that the smart earset itself having the keyword wakeup function can perform all of the transmitting and receiving processes.

According to the present invention, in addition, an embodiment in which the smart earset (Bluetooth earset for calling) having the keyword wakeup function is configured to have the in-ear microphone 2 and the speaker driver unit 3 built therein and to have the resonance case 4 applied to the speaker driver unit 3 will be explained.

According to the present invention, it is assumed that the smart earset is in a standby state after the pairing.

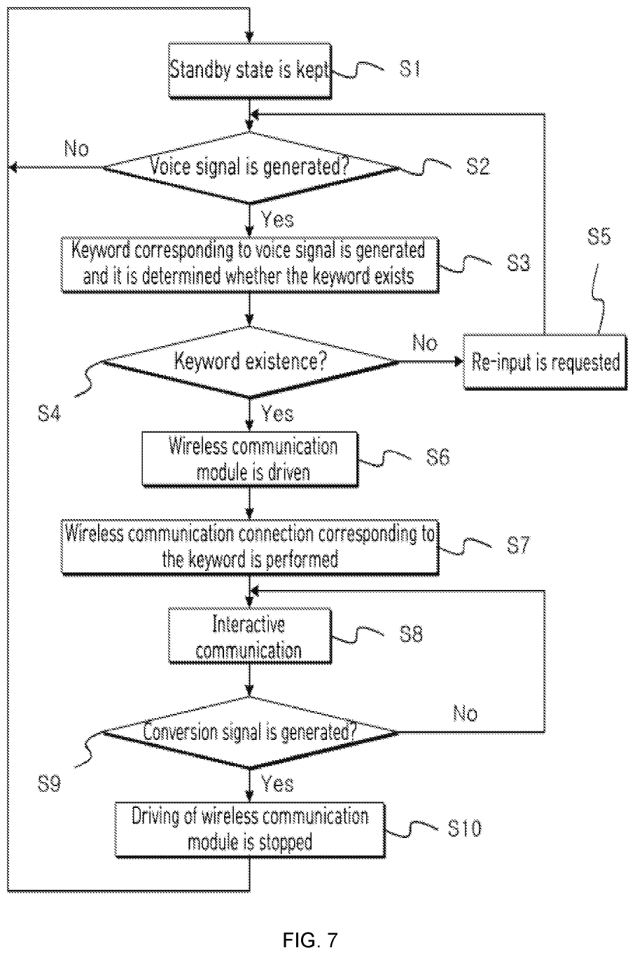

FIG. 7 is a flowchart showing a process wherein the smart earset having the keyword wakeup function according to the embodiment of the present invention is interlinked with a smartphone.

FIG. 7 shows a process wherein the smart earset having the keyword wakeup function as shown in FIG. 1 is driven.

Referring to FIG. 7, if a standby state is kept after first driving has been performed (at step S1), only the microphone 101 and the control unit 102 are driven to determine whether a voice signal is produced (at step S2). That is, as only the microphone 101 and the control unit 102 are driven, the smart earset can be driven with the minimum power.

If it is determined that the voice signal is produced, the keyword corresponding to the voice signal is generated, and next, it is determined whether the keyword is set in advance (at step S3). If external noise exists, the utterer's voice transferred through his or her mouth and the external noise are introduced through the through hole O of the case 1 into the smart earset, but the external noise is blocked out by means of the microhole H of the resonance case 4 or the through hole O and the mesh 5 of the resonance case 4, so that only the utterer's voice transferred to the ear canal through the Eustachian tube is introduced into the in-ear microphone 2 and is processed to the voice signal, thereby easily restoring to the utterer's original sounds in which the external noise is not included with ease. That is, the voice recognition rate is improved to produce the keyword accurately.

If it is determined that the keyword is not set in advance (at step S4), re-input is required (at step S5), and contrarily, if it is determined that the keyword is set in advance (at the step S4), the wireless communication module is driven (at step S6).

Next, the wireless communication connection corresponding to the keyword is carried out (at step S7). According to the present invention, on the other hand, an embodiment in which the wireless communication to the smartphone is performed is suggested, but if the keyword is a particular terminal or program, the wireless communication connection to the particular terminal or program is performed to execute the program.

Next, interactive communication through the wireless communication connection can be possible (at step S8).

If a conversion signal is produced from the smart earset or the smartphone (at step S9), further, the supply of the power source to the wireless communication module 103 is stopped by means of the control unit 102 (at step S10). In this case, the conversion signal is produced according to the voice production, smartphone operation, and elapsed time of an event.

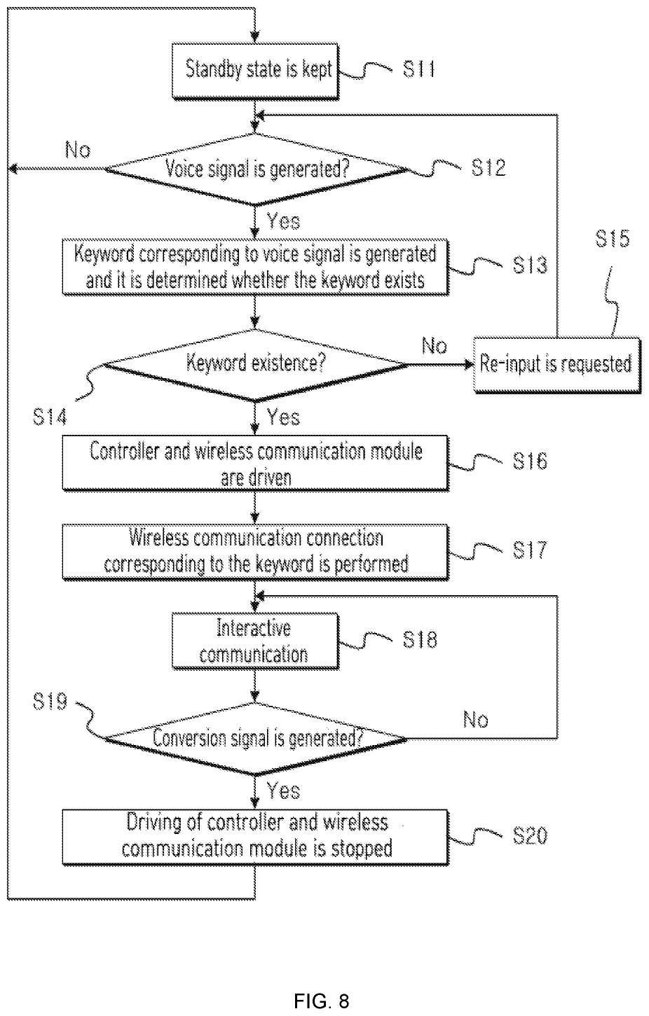

FIG. 8 is a flowchart showing a process wherein the smart earset having a keyword wakeup function according to another embodiment of the present invention is interlinked with a smartphone.

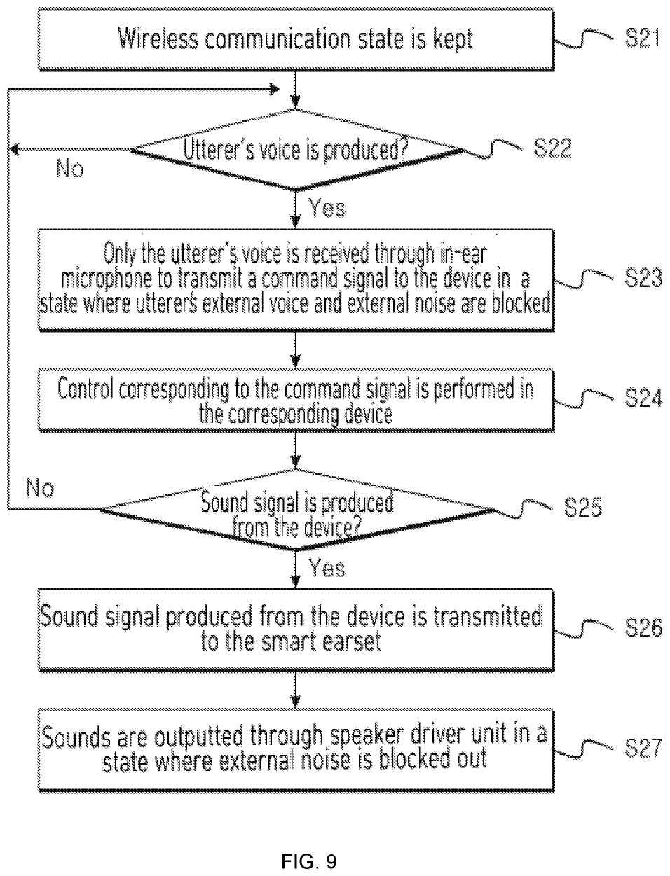

FIG. 9 shows a process wherein the smart earset having the keyword wakeup function as shown in FIG. 2 is driven.

Referring to FIG. 8, if a standby state is kept after first driving has been performed (at step S11), only the microphone 111 and the keyword determining unit 112 are driven to determine whether a voice signal is produced (at step S12). That is, as only the microphone 111 and the keyword determining unit 112 are driven, the smart earset can be driven with the minimum power.

If it is determined that the voice signal is produced, the keyword corresponding to the voice signal is generated by means of the keyword determining unit 112, and next, it is determined whether the keyword is set in advance (at step S13). If external noise exists, the utterer's voice transferred through his or her mouth and the external noise are introduced through the through hole O of the case 1 into the smart earset, but the external noise is blocked out by means of the microhole H of the resonance case 4 or the through hole O and the mesh 5 of the resonance case 4, so that only the utterer's voice transferred to the ear canal through the Eustachian tube is introduced into the in-ear microphone 2 and is processed to the voice signal, thereby easily restoring to the utterer's original sounds in which the external noise is not included with ease. That is, the voice recognition rate is improved to produce the keyword accurately.

If it is determined that the keyword is not set in advance (at step S14), re-input is required (at step S15). Contrarily, if it is determined that the keyword is set in advance (at the step S14), the controller 113 is driven, and the communication processing unit 114 is sequentially driven by means of the continuous control of the controller 113 (at step S16).

Next, the wireless communication connection corresponding to the keyword is carried out (at step S17). According to the present invention, on the other hand, an embodiment in which the wireless communication to the smartphone is performed is suggested, but if the keyword is a particular terminal or program, the wireless communication connection to the particular terminal or program is performed to execute the program.

Next, interactive communication through the wireless communication connection can be possible (at step S18).

If a conversion signal is produced from the smart earset or the smartphone (at step S19), further, the conversion signal is transferred to the controller 113. Accordingly, the supply of the power source to the communication processing unit 114 is stopped by means of the controller 113, and the controller 113 itself is converted into a standby state (at step S20). In this case, the conversion signal is produced according to the voice production, smartphone operation, and elapsed time of an event.

FIG. 9 is a flowchart showing a process wherein the smart earset having a keyword wakeup function according to the present invention is interlinked with a specific device.

Referring to FIG. 9, in a state of wireless communication (at step S21), it is determined whether an utterer's voice is produced (at step S22), and if the utterer's voice is produced, a command signal corresponding to the utterer's voice is produced.

In this case, the utterer's voice produced through his or her mouth and the external noise are introduced into the smart earset through the through hole O of the case 1, but they are blocked by means of the microhole H of the resonance case 4 or the through hole O and the mesh 5 of the resonance case 4, so that only the utterer's voice transferred to the ear canal through the Eustachian tube is introduced into the in-ear microphone 2 and is processed to the voice signal, thereby allowing the utterer's original sounds in which the external noise is not included to be easily restorable. Accordingly, the command signal can be accurately produced.

Next, the command signal is transmitted from the smart earset to the paired device (at step S23).

After that, the control corresponding to the command signal is performed in the device (at step S24).

If a sound signal is produced through the operation of the device (at step S25), further, the sound signal is transmitted to the smart earset (at step S26) and is then outputted through the speaker driver unit 3 (at step S27). In this case, even though external noise is introduced through the through hole O of the case 1 into the smart earset, the external noise is blocked out by means of the microhole H of the resonance case 4 or the through hole O and the mesh 5 of the resonance case 4, so that speaker sounds in which the external noise is not included can be outputted.

If the utterer's voice is produced during the output of the sounds through the speaker driver unit 3, further, the utterer's voice is received through the in-ear microphone 2, and if a command signal corresponding to the utterer's voice is produced, the utterer's command signal is transmitted to the corresponding device, so that the control corresponding to the command signal can be performed.

On the other hand, the embodiment as shown in FIG. 9 in which the in-ear microphone 2 and the speaker driver unit 3 are built in the smart earset have been explained, but in the case where the smart earset having an out-ear microphone 7 is adopted, if the utterer's voice is produced during the output of the sounds through the speaker driver unit 3, it is determined whether the utterer talks through the out-ear microphone 7, so that the volume of the sounds outputted at present through the speaker driver unit 3 can be reduced. This is to accurately receive the utterer's voice through the in-ear microphone 2. On the other hand, if the external noise with which the utterer's voice is mixed is greater than a set value, for example, 40 db, driving of the out-ear microphone 7 is stopped, and only the in-ear microphone 2 is driven, thereby desirably restoring to the utterer's original voice. In this case, desirably, the restoration to the utterer's original voice is carried out through the user's voice sample in advance stored.

As described above, the technical scope of the present invention has been described with reference to the particular illustrative embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

### INDUSTRIAL APPLICABILITY

The present invention can be usefully used in a place where noise is seriously generated.

1. A smart earset having a keyword wakeup function, comprising:
a microphone for collecting an utterer's voice to generate a voice signal;
a control unit for generating a keyword (wherein the keyword is a text that executes a particular program of a particular terminal) corresponding to the voice signal and generating a drive signal corresponding to the keyword; and
a wireless communication module driven correspondingly to the drive signal.

2. The smart earset according to claim 1, wherein the wireless communication module comprises:
a controller for driving a communication processing unit according to the drive signal and generating a conversion signal with which the communication processing unit is converted to a standby state under conditions set in advance; and
the communication processing unit for performing communication processing for signals inputted and outputted thereto and therefrom, and
the control unit serves as a keyword determining unit for determining whether the keyword exists.

3. The smart earset according to claim 2, wherein the control unit, the controller, and the communication processing unit are constituted as one chip.

4. The smart earset according to claim 1, wherein the microphone and the control unit are constituted as one chip.

5. The smart earset according to claim 1, wherein the microphone is an in-ear microphone that is isolatedly built from a speaker driver unit in which a back hole is formed, the speaker driver unit and the in-ear microphone being built in a case with a through hole formed thereon in such a manner as to be isolated from the through hole by means of a separator having a microhole adapted to allow the through hole to communicate with the back hole, and between the microhole and the back hole is formed a resonance space.

6. The smart earset according to claim 5, wherein the separator having the microhole is a resonance case adapted to cover the rear surface of the speaker driver unit on which the back hole is formed.

7. The smart earset according to claim 5, wherein the separator is an inner wall of the case.

8. The smart earset according to claim 5, wherein the separator is a printed circuit board (PCB).
